(19) United States
(12) Patent Application Publication
(10) Pub. No.: US 2023/0167663 A1
(43) Pub. Date: Jun. 1, 2023

(54) BARN DOOR TRACK SYSTEM AND RELATED METHODS OF INSTALLATION

(71) Applicant: International Moulding Co., Inc., Louisville, KY (US)

(72) Inventors: Bryan Ogle, Louisville, KY (US); David Stewart, Louisville, KY (US); Phil LaMarche, Aliso Viejo, CA (US)

(21) Appl. No.: 18/070,071

(22) Filed: Nov. 28, 2022

Related U.S. Application Data
(60) Provisional application No. 63/283,726, filed on Nov. 29, 2021.

(51) Int. Cl. E05D 15/06; E05D 5/02

(52) U.S. Cl. CPC E05D 15/0652; E05D 5/023

(57) ABSTRACT

A mounting system for mounting a door for movement adjacent an opening in a wall structure includes a cleat having a central web and two sides, a track plate having a central web and two sides, a track attached to the track plate, and at least one fastener for attaching the cleat to the wall structure. When mounted, the cleat extends lengthwise above the opening and engages drywall, the at least one fastener extends through at least one aperture defined by the cleat web and engages at least one stud(s) and/or header of the wall structure, and the first side of the track plate engages the first side of the cleat. A related door mounting method includes mounting a cleat to the wall structure, hanging a track plate on the cleat, securing the track plate to the cleat, and hanging the door on the track plate.

### RELATED METHODS OF INSTALLATION

This application claims the benefit of U.S. Provisional Patent Application No. 63/283,726, filed Nov. 29 2021, the disclosure of which is incorporated herein by reference.

### FIELD OF THE INVENTION

This document relates generally to mounting systems, and more specifically to mounting systems for barn door tracks and their installation.

### BACKGROUND OF THE INVENTION

Current barn door products and their support hardware are a challenge to install with most designs requiring the installation of wood (or other material) blocking above a wall opening to ensure the track is suitably anchored and the door hardware properly functioning. Blocking typically reinforces the header of the framed opening and allows the weight of the load of the barn door hardware and door panel(s) to be more evenly distributed. This prevents any of the weight load from being transferred onto the drywall and limits the possibility of the mounting system and track pulling apart from the wall and the track/system and barn door(s) falling. Such can occur when installers take short cuts, such as not installing blocking or not properly blocking, that can lead to premature failure of the mounting system.

In new construction, for example, 2×4s, 2×8s, or 4×4s are commonly used for blocking. These can be installed between wall studs prior to drywall installation. It should be noted that the studs can be wood, metal, or other standard construction material. If the project is a remodel and the opening is to remain as-is, however, the drywall may then be required to be partially cut away to accommodate installation of the blocking. Disrupting an existing wall structure is certainly not desirable in part because of extended installation times and a less finished overall look due to the replacement and painting of the new drywall portions. The alternative is installation of an external, surface-mounted header which is less aesthetically pleasing.

While routine, the installation of blocking and resulting repair to the drywall can significantly increase installation times even for those with significant experience. Accordingly, a need exists for a mounting system that avoids the need tor blocking, either during new construction, renovation, or remodel, and a related method of efficiently and safely mounting or installing such a system.

### SUMMARY OF THE INVENTION

In accordance with the purposes and benefits described herein, a mounting system for mounting a door for movement adjacent an opening in a wall structure for selectively opening and closing the opening, the wall structure having drywall attached to a plurality of studs and a header positioned over the opening, and related methods of mounting the door are provided.

The mounting system may be broadly described as including a cleat having a central web and first and second sides, a track plate having a central web and first and second sides, a track attached to the track plate, and at least one fastener for attaching the cleat to the wall structure. In the mounted position, the cleat extends lengthwise above the opening and engages the drywall, the at least one fastener extends through at least one aperture defined by the cleat central web and engages at least one of the plurality of studs and/or the header of the wall structure, and the first side of the track plate engages the first side of the cleat.

In another possible embodiment, at least the first side of the cleat is outwardly angled relative the second side of the cleat, and the first side of the track is inwardly angled.

In yet another possible embodiment, the mounting system further includes at least one other fastener for engaging the second side of the track plate and the second side of the cleat to at least restrict relative movement between the track plate and the cleat.

In still another possible embodiment, the second side of the cleat is outwardly angled relative the first side of the cleat.

In one other possible embodiment, the at least one other fastener is a set screw that engages a threaded hole in the second side of the track plate.

In still another possible embodiment, the second side of the track plate is substantially perpendicular to the wall in the mounted position.

In one other possible embodiment, the at least one aperture defined by the cleat central web includes a plurality of slots formed in first and second rows such that the slots formed in the first row are offset relative the slots formed in the second row.

In accordance with another possible embodiment, a mounting system includes a cleat having a substantially U-shaped transverse cross-sectional shape, with a central web and first and second angularly outwardly divergent sides, a track plate having a central web, a first inwardly angled side and a second side each extending from the track plate central web, and at least one fastener for attaching the cleat to the wall structure and at least one other fastener for securing the track plate to the cleat in a mounted position. In the mounted position, the cleat extends lengthwise above the opening and engages the drywall, the at least one fastener extends through at least one aperture defined by the cleat central web and engages at least one of the plurality of studs and/or the header of the wail structure, the first inwardly angled side of the track plate engages the first angularly outwardly divergent side of the cleat.

In another possible embodiment, the mounting system further includes a track attached to Ike track plate for receiving the door.

In one other possible embodiment, the at least one other fastener engages the second side of the track plate and the second angularly outwardly divergent side of the cleat to at least restrict relative movement between the track plate and the cleat.

In yet another possible embodiment, the at least one other fastener is a set screw that engages a threaded hole in the second side of the track plate.

In still another possible embodiment, the second side of the track plate is substantially perpendicular to the wall in the mounted position.

In yet on other possible embodiment, the cleat is received entirely within the track plate.

In still one other possible embodiment, the at least one aperture defined by the cleat central web includes a plurality of slots formed in first and second parallel rows.

In accordance with another aspect, a method of mounting a door for movement adjacent an opening in a wall structure for selectively opening and closing the opening, the wall structure haying drywall attached to a plurality of studs and a header positioned over the opening, is provided. The method may be broadly described as comprising the steps of: (a) mounting a cleat to the wall structure such that the cleat extends lengthwise above the opening and a central web of the cleat engages the drywall, the cleat having a first side outwardly angled relative a second side; (b) hanging a track plate on the cleat by positioning a first inwardly angled side of a track plate over the first side of the cleat and lowering the track plate onto the cleat such that the first side of the track plate engages the first side of the cleat; (c) securing the track plate to the cleat, and (d) hanging the door on the track plate.

In one other possible embodiment, the mounting step includes inserting at least one fastener through at least one aperture defined by the cleat central web and into engagement with at least one of the plurality of studs and/or the header of the w all structure.

In yet another possible embodiment, the cleat has a substantially U-shaped transverse cross-sectional shape and the first and second sides are angularly outwardly divergent.

In still another possible embodiment, the securing step includes engaging a threaded hole in the second side of the track plate and the second side of the cleat with at least one other fastener.

In yet one other possible embodiment, the securing step includes engaging a threaded hole in the second side of the track plate and the second side of the cleat with at least one other fastener.

In one other possible embodiment, the cleat has a substantially U-shaped transverse cross-sectional shape and the first and second sides are angularly outwardly divergent.

In the following description, there arc shown and described several preferred embodiments of a mounting system for mounting a door for movement adjacent an opening in a wall structure for selectively opening and closing the opening and related methods of mounting same. As it should be realized, the systems and methods are capable of oilier, different embodiments and their several details are capable of modification in various, obvious aspects all without departing from the methods and systems as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the invention and methods and together with the description serve to explain certain principles thereof. In the drawing figures:

FIG. 1 is a perspective view of a wall structure showing a cleat positioned over an opening and attached to wall studs and a header revealed through a partial cutaway of a dry wall of the wall structure;

FIG. 2 is an exemplary illustration of a moving bam door and hardware hanging adjacent an opening in a wall structure;

FIG. 3 is a perspective view of the wall structure and the cleat engagingly attached thereto and a track plate shown suspended above the cleat in a to-be installed position;

FIG. 4 is a side plan view of the cleat attached to the wall structure with the track plate shown suspended above the cleat in the to-be installed position; and

FIG. 5 is a side plan view of the track plate mounted in position over the cleat and secured thereto by set screws.

Reference will now be made in detail to the present described embodiments of the mounting system for mounting a door for movement adjacent an opening in a wall structure for selectively opening and closing the opening and related methods for mounting same, examples of which arc illustrated in the accompanying drawing figures, wherein like numerals are used to represent like elements.

### DETAILED DESCRIPTION

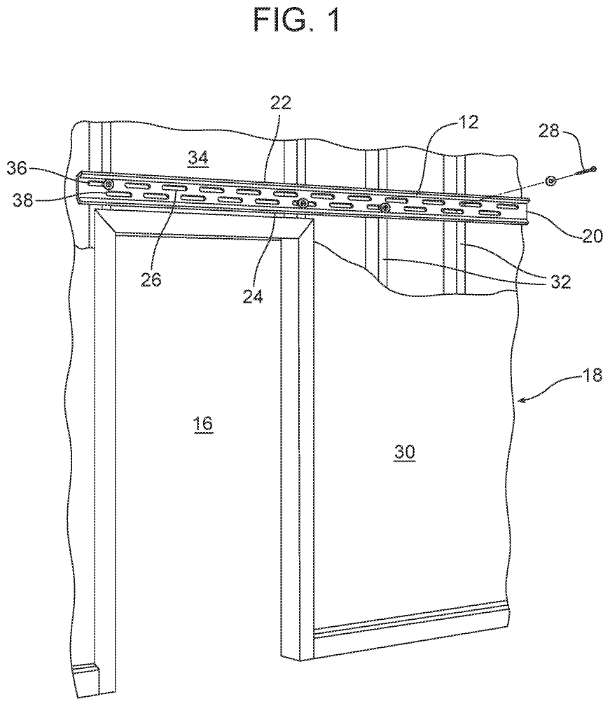

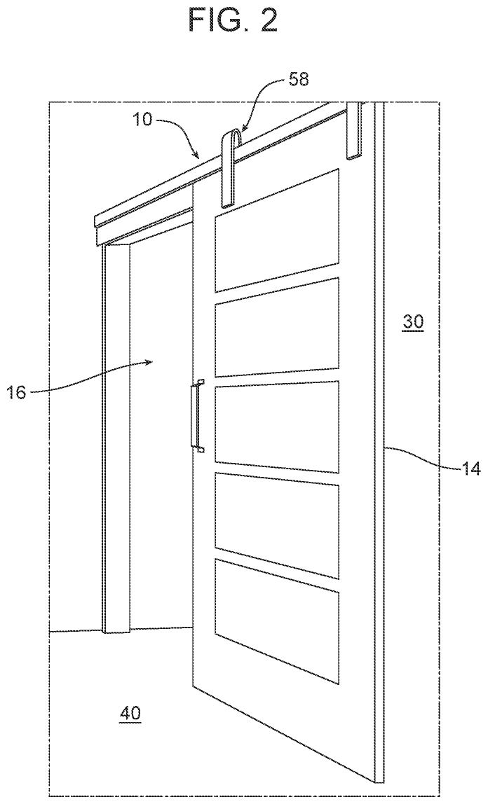

Reference is now made to FIG. 1 which illustrates a cleat 12 of a mounting system 10. The mounting system 10 is designed to support a door assembly, including a door 14 for movement over an opening 16 in a wall structure 18. The opening may be a doorway, a window, a balcony, or any other type of opening. An exemplary moving bam door 14 is shown adjacent an opening 16 in a wail structure 18 in an open position in FIG. 2. As is known in the art, the door 14 may be moved, manually or otherwise, from the open position to an intermediate position partially covering the opening 16 and/or a closed position wherein the opening is fully covered.

In alternate embodiments, the mounting system 10 may include more than one cleat 12 extending lengthwise above the opening 16. In all embodiments, the cleat(s) 12 serve to strengthen the wail structure 18 for supporting the door 14. As shown, each cleat 11 is generally U-shaped in transverse cross-section, having a longitudinal center web 20 and outwardly divergent side walls 22 and 24, and includes at least one slot 26 defined by the center web through which fasteners 28 may extend through a wallboard or drywall 30 and directly into a stud 32 and/or a header 34 of the wall structure 18.

In other embodiments, the one or more cleats may include one or more holes or apertures in the center web in lieu of or in addition to the one or more slots such that a first fastener can be installed through a hole/aperture into a stud or header, for example, and a second fastener can be installed through the slot into a stud or header. The utilization of one or more slots 26 in the center web 20 in this manner provides variation in attachment points to ensure the fasteners 28 can be positioned so as to engage a stud 32/header 34. By mounting the cleat 12 directly to the studs 32 and/or a header 34 of the wall structure 18, the need for additional support provided by blocking above or adjacent the opening is eliminated while ensuring the cleat 12 is securely anchored or attached to the wall structure.

In the described embodiment, a single cleat 12 is used having first and second rows of slots 36, 38 formed in the center web 20. More specifically, the first and second rows 36, 38 are substantially parallel to one another and each row includes multiple end-to-end slots 26 extending lengthwise along the center web 20 of the cleat 12. The slots 26 in the first and second rows of slots 36, 38 in the center web 20 may align or may be offset to varying degrees, as shown in FIG. 1, to support alignment of the fasteners 28 with the studs 32 and headboard 34. As shown in the inset in FIG. 1, the cleat 12 is mounted to the wall studs 32 using standard fasteners 28 such as lag bolts or lag screws and a washer(s) as desired. Of course, any suitable fastener may be used.

In all embodiments, the cleat 12 is positioned above the wall opening 16. Most commonly, the cleat 12 is offset from a center position over the opening 16 but may be centered over the opening in certain instances. Once positioned, the slots 26 allow the fasteners 28 to be installed through the center web 20 of the cleat 12 and drywall 30 and directly into the studs 32 and/or header 34 securing the cleat in the selected position. The slots 26 also accommodate leveling of the cleat 12 relative the w all opening 16 or a floor 40.

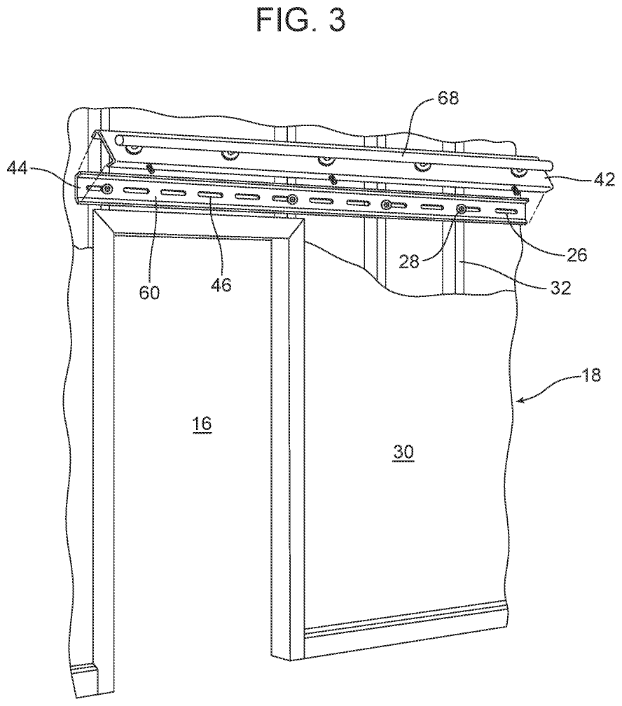

As best exemplified in FIGS. 3-5, a door track plate 42 is positioned over a mounted cleat 44. In the described embodiment, the cleat 44 includes a single row of slots 46 formed in a center web 60. Positioning the track plate 42 over the mounted cleat 44, as best shown in FIG. 4, allows the cleat to be received within the track plate such that the entirety of the cleat is within the track plate and obscured from view. The generally hollow and open-ended nature of the track plate 42 in the described embodiment is best illustrated in FIG. 4. Other embodiments, may utilize closed or partially closed ends.

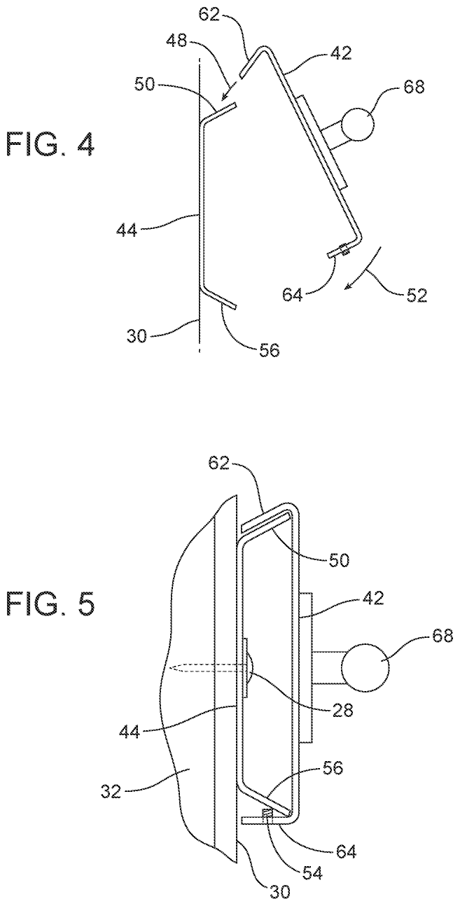

During installation, the track plate 42 is initially positioned above and subsequently lowered onto the mounted cleat 44 as exemplified by action arrow 48. In other words, the track plate 42 is hung on the cleat 44 such that a first inwardly angled side 62 of the track plate engages a first, outwardly divergent side wall 50 of the cleat restricting movement of the track plate in a vertical direction. As further illustrated by action arrow 52, once the track plate 42 engages the first side wall 50 of the cleat 44, a lower portion of the track plate is rotated toward the drywall 30 such that a second side 64 abuts the drywall (shown in FIG. 5).

The track plate 42 also provides an adjustment mechanism. In the embodiment described and shown in FIGS. 4-6, set screws 54 are used to secure the track plate 42, once horizontally aligned, to the cleat 44. As specifically shown in FIG. 5, headless set screws fa engage threaded holes in the second side 64 of the track plate 42 and are tightened so as to engage a second, outwardly divergent side wall 56 of the cleat 44. It should be noted that while three set screws arc illustrated in the described embodiment, other embodiments may use any number of set screws or other fasteners to secure the track plate to the cleat. Such engagement restricts relative movement between the track plate 42 and the cleat 44 in any direction and maintains a secure connection. Relative movement is defined as the individual movement of one object relative a second object. For example, when there is no relative movement between two objects, the objects, if they move at all, move together as if they were a single object.

In each of the described embodiments, the track plate 42 and door assembly 58 are provided fully assembled while in other embodiments, either may be at least partially assembled on site. In addition, the door assembly 58 may include slide stoppers (not shown) on either or both ends of the track, a roll bar (not shown), and rollers (not shown) attached to a top of the door 14. The completed door assembly 58 is hung. More specifically, a hangar or track 68 is attached to the track plate 42 for receiving two or more rollers attached to the door 14. The track 68 may take many forms including a bar, a rod, a J-shaped track, etc. depending on the door mounting hardware as is generally known in the art. The slide stoppers may be adjusted depending on desired movement of the door(s).

A method is described for installing a mounting system 10 intended for use in supporting a door assembly 58, including a door 14 over a wall opening 16. A cleat 12 having at least one slot 26 formed therein is fastened to a wall structure 18 and, more specifically, to one or more wall studs 32 and/or a header 34. The cleat 12 may alternatively include one or more rows of end-to-end slots 26 with the rows formed in a parallel configuration or otherwise. Fasteners 28 are used to secure the cleat 12 to the wall structure 18. Once secured, a track plate 42 is positioned over or hung from the cleat 12 so as to restrict movement in a vertical direction. In the described method, a lower portion of the track plate 42 is rotated outward or maintained away from the drywall 30 allowing a tapered upper portion of the track plate to engage a first side wall 22 of the cleat 12. Once engaged, the lower portion of the track plate 42 is rotated back toward the drywall 30.

Next, the track plate 42 is aligned horizontally on the cleat 12 to accommodate movement of the door 14 over the opening 16 and the overall look of the track plate and hanging door assembly 58. In the described embodiment, headless set screws 54 are used to engage a second side wall 24 of the cleat 12 restricting movement of the cleat in any direction. Once the track plate 42 is positioned, the door assembly 58, including at least a door and rollers may be hung.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A mounting system for mounting a door for movement adjacent an opening in a wall structure for selectively opening and closing the opening, the wall structure having drywall attached to a plurality of studs and a header positioned over the opening, the mounting system comprising:
a cleat having a substantially U-shaped transverse cross-sectional shape, with a central web and first and second angularly outwardly divergent sides;
a track plate having a central web, a first inwardly angled side and a second side each extending from the track plate central web; and
at least one fastener for attaching the cleat to the wall structure and at least one other fastener for securing the track plate to the cleat in a mounted position,
wherein the cleat extends lengthwise above the opening and engages the drywall, the at least one fastener extends through at least one aperture defined by the cleat central web and engages at least one of the plurality of studs and/or the header of the wall structure, the first inwardly angled side of the track plate engages the first angularly outwardly divergent side of the cleat, all when in the mounted position.

2. The mounting system of claim 1, further comprising a track attached to the track plate for receiving the door.

3. The mounting system of claim 2, wherein the at least one other fastener engages the second side of the track plate and the second angularly outwardly divergent side of the cleat to at least restrict relative movement between the track plate and the cleat

4. The mounting system of claim 3, wherein the at least one other fastener is a set screw that engages a threaded hole in the second side of the track plate.

5. The mounting system of claim 1, wherein the second side of the track plate is substantially perpendicular to the wall in the mounted position.

6. The mounting system of claim 1, wherein the cleat is received entirely within the track plate.

7. The mounting system of claim 1, wherein the at least one aperture defined by the cleat central web includes a plurality of slots formed in first and second parallel rows.

8. A mounting system for mounting a door for movement adjacent an opening in a wall structure for selectively opening and closing the opening, the wall structure having drywall attached to a plurality of studs and a header positioned over the opening, the mounting system comprising:
a cleat having a central web and first and second sides;
a track plate having a central web and first and second sides;
a track attached to the track plate; and
at least one fastener for attaching the cleat to the wall structure,
wherein the cleat extends lengthwise above the opening and engages the drywall, the at least one fastener extends through at least one aperture defined by the cleat central web and engages at least one of the plurality of studs and/or the header of the wall structure, the first side of the track plate engages the first side of the cleat, all when in the mounted position.

9. The mounting system of claim 8, wherein at least the first side of the cleat is outwardly angled relative the second side of the cleat, and the first side of the track is inwardly angled.

10. The mounting system of claim 9, further comprising at least one other fastener for engaging the second side of the track plate and the second side of the cleat to at least restrict relative movement between the track plate and the cleat.

11. The mounting system of claim 10, wherein the second side of the cleat is outwardly angled relative the first side of the cleat.

12. The mounting system of claim 10, wherein the at least one other fastener is a set screw that engages a threaded hole in the second side of the track plate.

13. The mounting system of claim 12, wherein the second side of the track plate is substantially perpendicular to the wall in the mounted position.

14. The mounting system of claim 9, wherein the at least one aperture defined by the cleat central web includes a plurality of slots formed in first and second rows such that the slots formed in the first row are offset relative the slots formed in the second row.

15. A method of mounting a door for movement adjacent an opening in a wall structure for selectively opening and closing the opening, the wall structure having drywall attached to a plurality of studs and a header positioned over the opening, the method comprising the steps of :
mounting a cleat to the wall structure such that the cleat extends lengthwise above the opening and a central web of the cleat engages the drywall, the cleat having a first side outwardly angled relative a second side;
hanging a track plate on the cleat by positioning a first inwardly angled side of a track plate over the first side of the cleat and lowering the track plate onto the cleat such that the first side of the track plate engages the first side of the cleat;
securing the track plate to the cleat; and
hanging the door on the track plate.

16. The method of mounting a door of claim 15, wherein mounting step includes inserting at least one fastener through at least one aperture defined by the cleat central web and into engagement with at least one of the plurality of studs and/or the header of the wall structure.

17. The method for mounting a door of claim 16, wherein the cleat has a substantially U-shaped transverse cross-sectional shape and the first and second sides are angularly outwardly divergent.

18. The method for mounting a door of claim 16, wherein the securing step includes engaging a threaded hole in the second side of the track plate and the second side of the cleat with at least one other fastener.

19. The method for mounting a door of claim 15, wherein the securing step includes engaging a threaded hole in the second side of the track plate and the second side of the cleat with at least one other fastener.

20. The method for mounting a door of claim 19, wherein the cleat has a substantially U-shaped transverse cross-sectional shape and the first and second sides are angularly outwardly divergent.
